(19) United States
(12) Patent Application Publication
(10) Pub. No.: US 2012/0167395 A1
(43) Pub. Date: Jul. 5, 2012

(54) HEDGE TRIMMER AND A BLADE THEREFORE

(75) Inventors: Colin Duffy, Banbury (GB); Martin Lugert, Gunzburg (DE)

(73) Assignee: GARDENA MANUFACTURING GMBH, Ulm (DE)

(21) Appl. No.: 13/394,921

(22) PCT Filed: Sep. 9, 2009
(86) PCT No.: PCT/EP2009/006525

§ 371 Date: Mar. 8, 2012

(51) Int. Cl. A01G 3/04; B23D 35/00

(52) U.S. Cl. 30/223; 30/225

(57) ABSTRACT

A blade 1 for a hedge trimmer having a long axis and comprising a plurality of cutting teeth, each tooth having a longitudinal axis extending laterally away from the long axis of the blade 1, each cutting tooth comprising a root and a tip and opposing sides extending between the root and the tip, characterised in that at least one of the cutting teeth comprises a special tooth which is sharpened along at least one side to form a cutting edge, in which a first portion of the cutting edge is bevelled such that a tangent line to the first portion is inclined at an angle of between 1 degrees and 6 degrees relative to the longitudinal axis of the tooth, and a second portion of the cutting edge closer to the tip of the tooth than the first portion and which is bevelled such that a tangent line to the second portion is inclined at an angle relative to the longitudinal axis of the tooth of between 8 degrees and 25 degrees.

This invention relates to a cutting blade for a hedge trimmer, and to hedge trimmers which include a cutting blade.

Hedge trimmers of known kind comprise at least one movable blade and a second blade which may be fixed in a single action type trimmer or may also move in a double action type trimmer. The blades each comprise laterally protruding teeth arranged at spaced intervals along the length of the blade. In use the blades move to and fro relative to one another along their long axes in a reciprocating manner. This motion causes the teeth of the respective blades to move towards and away from each other in a scissor type action, to open and close branch receiving spaces between adjacent teeth. Any branches entering such a space when open will be cut as the teeth move together closing the space.

It is known to provide a blade for a hedge trimmer of the aforementioned kind which has a plurality of symmetrical teeth on the first blade whose cutting edges are slanted uniformly from the root to the tip of the tooth, e.g. the edges are inclined at some small angle away from an imaginary line that extends perpendicular to the long axis of the blade. This incline of the tooth edge allows fine branches to reach the bottom of the space between teeth, whilst coarser branches can only extend part way into the space.

It is also known that the teeth of the second blade may be extended a greater distance laterally than the teeth of the first blade to form blunt extensions or guards which take no part in a cutting action with the teeth of the other blade but help to ensure oversized branches are kept away from the cutting edges and at the same time offer an additional protective feature to the user.

According to a first aspect of the invention, there is provided a blade for a hedge trimmer having a long axis and comprising a plurality of cutting teeth, each tooth having a longitudinal axis extending laterally away from the long axis of the blade, each cutting tooth comprising a root and a tip and opposing flanks extending between the root and the tip, characterised in that at least one of the cutting teeth comprises a special tooth which is sharpened along at least one flank to form a cutting edge, in which a first portion of the cutting edge is bevelled such that a tangent line to the first portion is inclined at an angle of between 1 degrees and 12 degrees relative to the longitudinal axis of the tooth, and a second portion of the cutting edge closer to the tip of the tooth than the first portion and which is bevelled such that a tangent line to the second portion is inclined at an angle relative to the longitudinal axis of the tooth of between 8 degrees and 25 degrees, the angle of inclination of the second portion being greater than that of the first portion.

In use of the blade with a hedge trimmer, the shape of the cutting edge of the special tooth may be so arranged as to reduce the cutting force imparted on the extremities of the tooth by large branches as the second portion provides most of the cutting action, enabling a sawing action to be achieved by the tooth as it moves. Smaller branches which impose less cutting resistance may be sliced by the first portion nearer the root of the tooth. Because this portion is closer to being orthogonal to the long axis of the blade there is less chance of a small branch being pushed, or cammed, away from the bottom of the branch receiving spaces by the closing cutting edge which creates a clean cut.

Each bevelled portion may comprise a substantially straight linear segment whereby the tangent line for that portion will overlie the whole of the portion with the line considered to be a portion of a perimeter of a circle of infinite radius.

Alternatively, each portion may be curved in which case the tangent line will be the imaginary line that just touches the curved portion at a point along its length. The first portion may be curved such that there are no points which have tangents that are inclined at an angle greater than 6 degrees, and the second portion may be curved such that there are no points which have tangents less than 8 degrees and greater than 25 degrees. Thus the second portion is more inclined than the first to give the sawing action on larger branches that has been found to be advantageous.

The first and second bevelled portions may be adjacent and meet at a point. Alternatively, an additional portion, which may be of constant radius may connect the first and second portions such that the end of the first and second portions are tangential to the ends of the curved portion.

The first and second portions may be inclined inwardly from the root end to the tip end such that the length of a tangent extending out from the central axis of the tooth to meet the sharpened edge along each of these portions decreases with increasing distance from the root of the tooth.

Alternatively, the first portion may incline outwards whilst the second portion is inclined inwards with increasing distance from the root of the tooth.

The first portion may extend over a lower or a central region of the cutting edge, and the second portion may extend across the upper region of the cutting edge. Each portion may extend along at least 10 percent, and preferably at least 25 percent of the cutting edge and up to 40 percent and preferably over that length the tangent to any point must be within the stated ranges. By upper in this case we mean the tip end of the tooth, and by lower we mean the root end.

The lower end of the first portion may be located at most half way up the cutting edge and preferably at most 25 percent of the way, and the upper end may be located at least 60 percent of the way from the tip of the tooth.

Similarly the second portion may extend over at least 50 percent, 80 percent or substantially 100 percent of the upper 25 percent of the tooth cutting edge.

The transition between the first portion and the second portion may be located between 20 percent and 90 percent of the distance from the root to the tip of the tooth as measured from the root of the tooth.

Most preferably the first portion extends over a length of the cutting edge with one end located approximately one quarter of the way up the cutting edge (measured from the root) to around one half of the way, and the second portion extending from around half of the way to the top of the tooth cutting edge, or close to the top of the cutting edge. Over the lower quarter of the tooth the cutting edge may be curved so as to gradually transition from being generally parallel to the long axis of the blade to being at the same incline as the lower end of the first portion at its upper end (upper again meaning the end nearest the tooth tip).

The first and second portions may be shaped such that for any point on the edge its tangent is the same as, or inclined at a greater angle than, any point on the edge that is below it, i.e. closer to the root.

The tooth may be symmetrical about its longitudinal axis which itself may be orthogonal to the long axis of the blade. It may therefore have two sharpened edges, one each side of the central axis, which each of which comprises first and second bevelled portions as required by the first aspect of the invention.

The tip of the tooth may comprise a third portion which is inclined relative to the long axis of the blade (which is typically perpendicular to the axis of the tooth) at an angle of between 4 degrees and 20 degrees extending from one side edge of the tooth to its length axis, and preferably across to the other side edge and which in use provides a sawing action. The edges may be sharpened right up to this linear tip portion. An angle of 5 degrees or 8 degrees is preferred.

The third portion may be concave, either V-shaped or U-shaped so as to provide two acute corners on the tip of the tooth.

In one arrangement the angle of the first portion may be 6 degrees, the second portion is 12 degrees and the angle of the third portion is 5 degrees. In another arrangement the first, second and third angles may be 4, 20 and 8 degrees respectively.

The blade may include at least two special teeth which are adjacent, which are as required by the foregoing, and in which the third portion of adjacent teeth are inclined in opposing directions relative to the long axis of the blade.

The blade may comprise at least two, and preferably at least four special teeth and one or more normal teeth which comprise opposing sharpened cutting edges that taper linearly towards the centre axis of the tooth from a point at or near to the root of the tooth to a point at or near the tip of the tooth. These normal teeth are therefore thinner near the tips than at the root but do not feature the novel double bevel of the special teeth.

The special teeth may be located at the end of the blade which, in use, is furthest from the handle of the hedge trimmer with the normal teeth being located closer to the handle of the trimmer.

The teeth of the blade may be spaced at regular intervals along the blade length.

According to a second aspect the invention provides a hedge trimmer comprising at least two blades, a first blade of which is in accordance with the first aspect of the invention and a second blade.

The second blade may also comprise teeth spaced along a long axis of the blade, at least one of the teeth of the second blade being longer from root to tip than the teeth of the first blade to provide extensions which restrict contact between oversized branches and the teeth of the first blade.

The extensions of the second blade may have blunt edges.

The first blade may be arranged to reciprocate along its long axis relative to the second blade which may be fixed. Alternatively both the first and second blades may be arranged to reciprocate relative to one another to provide a dual cutting action.

There now follows, by way of example only, embodiments of the invention, described with reference to the accompanying drawings, in which:

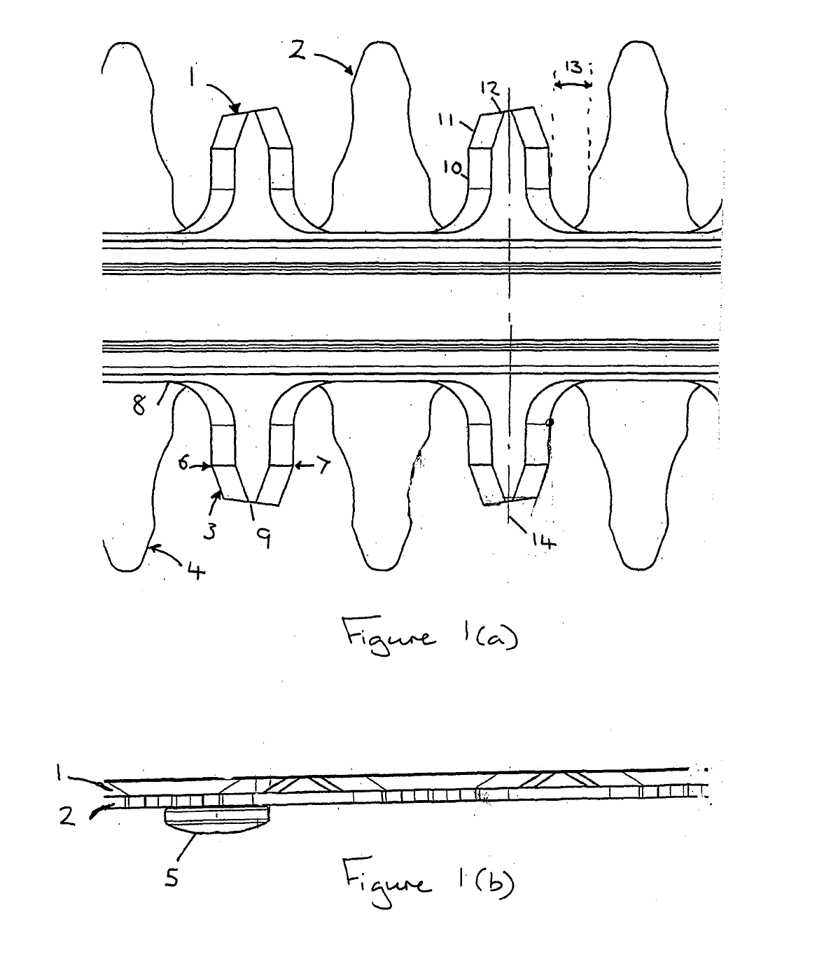

FIG. 1(a) shows a portion of a hedge trimmer with detail in side elevation of a section of an first blade and a second blade, the first blade comprising an embodiment falling within the scope of the first aspect of the invention;

FIG. 1(b) shows the same section as top elevation view;

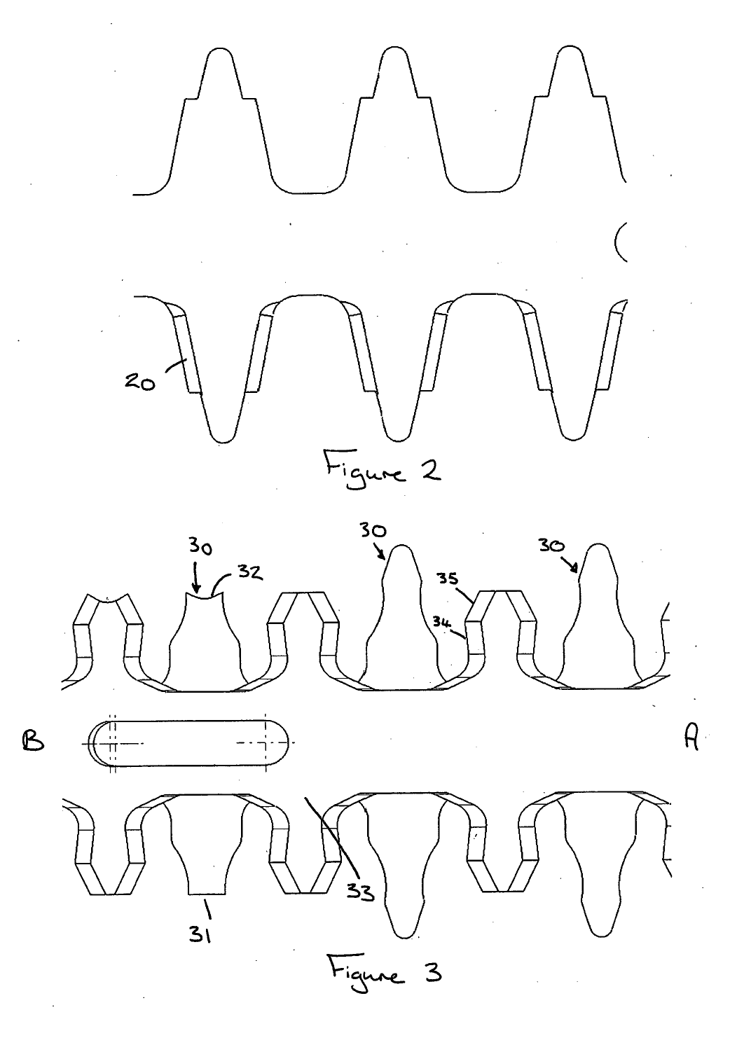

FIG. 2 shows a view of an alternative lower blade;

FIG. 3 shows a view similar to that of FIG. 1(a) of an first blade and second blade according to a second embodiment of the invention;

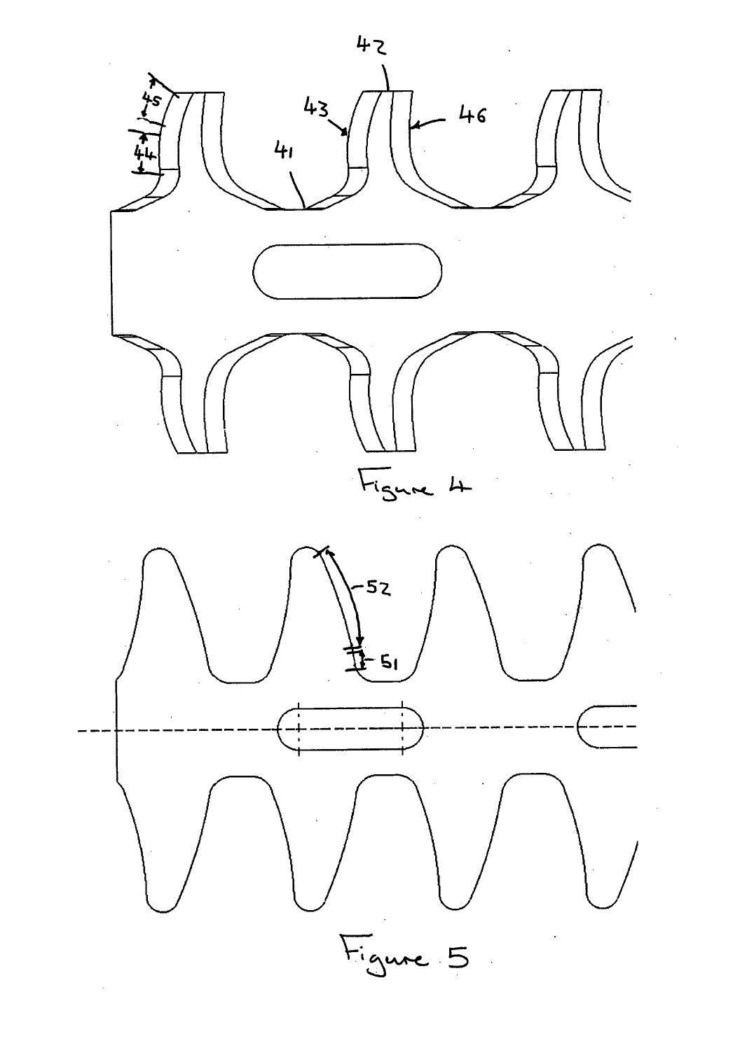

FIG. 4 shows a side elevation view of a third embodiment of a blade in accordance with the first aspect of the invention;

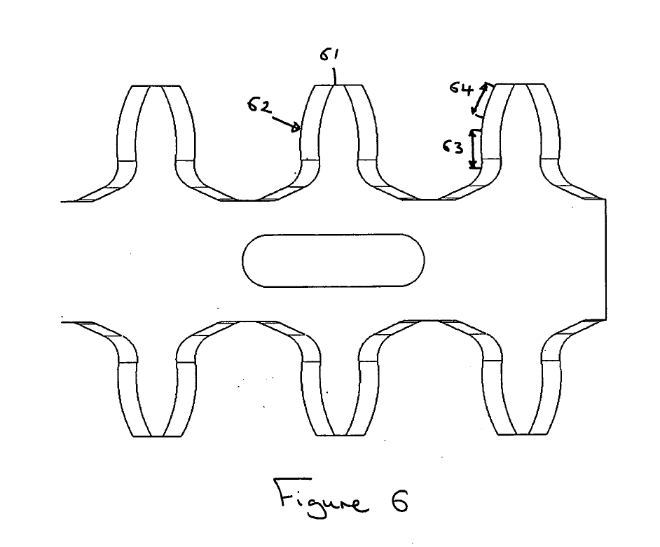

FIG. 5 shows a side elevation view of a fourth embodiment of a blade in accordance with the first aspect of the invention; and

FIG. 6 shows a side elevation view of a fifth embodiment of a blade in accordance with the first aspect of the invention.

A mid-section of the blades of a hedge trimmer according to an embodiment of the invention are shown in FIG. 1. Two blades are provided; a first blade 1 and a second blade 2. The first blade 1 is positioned on top of the second blade 2 with a sliding contact in between. The first blade 1 and second blades 2 are driven through a motor and transmission (not shown) in opposing forward and backward reciprocating motions. Each blade 1,2 is provided with a set of teeth, the teeth 3 on the first blade move in the opposite but parallel direction to the teeth 4 on the second blade, although it is possible for the second blade 2 not to move at all. This causes the teeth to move together and apart sheering material with lies in spaces that form between the cutting edges of adjacent teeth on the first and second blades.

The blades are prevented from sliding perpendicularly to the driven direction by guide pins 5 which extend through holes (not shown) in the blades. In this embodiment, at least some of the first teeth 3 of the first blade comprise special teeth have cutting edges 6, 7 on either side of the longitudinal axis 14 of each tooth extending from the root of the tooth towards the tip to allow cutting with both the forward and backward motion of the teeth. These cutting edges are sharpened from the root 8 to the tip 9 providing a large cutting region. Teeth are positioned on both sides of the blades to allow the trimmer to be used with a sweeping movement and so the trimmer cuts on both the forward and reverse sweeps.

Cutting edges 20 may be provided on the second blade as shown in FIG. 2. This optional feature has been found to improve the quality of the cut by more cleanly slicing through hedge growth and reducing the force transferred to the gearbox and blades.

FIG. 3 shows a small section from the length of the two cutting blades according to a second embodiment of the present invention. The teeth show a first portion 34 and a second portion 35. The section is taken roughly 400 mm from the unit body which provides drive for the blades and controls for the operator. The unit body is positioned further down the blade on the side labelled A. The tip of the blade furthest from the operator is on the side labelled B. The tips 31 of the teeth on the second blade 30 towards end B have the blunt edges removed. This makes end B more suitable for providing a sawing on larger branches and end A better for a finer cuts on smaller branches. The operator has more control of the blade at end A since it is closer to the unit body which is beneficial for more precise control of the finer cutting.

The teeth on the opposite side of the blade at end B have a profile 32 on the tip to improve cutting on larger branches. The profile 32 forms two points on the tip of each tooth which act as pressure points and can improving sawing through thicker branches.

Every tooth has a wide root 33 which reduces stress concentrations at the base of the tooth. High stress concentrations cause flaws to initiate under fatigue and cracks may grow in the blade material potentially resulting in a tooth breaking off the blade.

On the first blade 1 shown in FIG. 1a, the profile of the sharpened side edges of the teeth between the root 8 and the tip 9 are shaped to include two bevelled portions 10 and 11 whilst the tip itself is also bevelled and forms a third portion 12. A range of angles may be used but in two preferred arrangements the first portion is inclined at an angle of 1 degree or 6 degrees relative to the axis of the tooth, the second at an angle of 20 or 12 degrees relative to the axis of the tooth and the third an angle of 5 degrees relative to the long axis of the blade (85 degrees relative to the axis of the tooth). In this example each bevelled portion comprises a substantially straight edge that meets the adjacent portion at a point forming an obtuse angle.

The teeth are so shaped that the second and third portions provide some pre-cutting to thicker branches with the tips of the teeth using a sawing action before eventually slicing through the branch. The teeth are designed to reduce the cutting force imparted on the blades towards the extremities of the teeth at the tips. This reduces the wear and load on the teeth particularly when cutting thick branches. The cutting force imparted on the cutting edge is highest at 10 and reduces with the angle from 11 to 12. The maximum gap 13 between the teeth on the first blade 1 and the second blade 2 should not allow branches of a thickness which would jam the blades to enter. Instead those branches are progressively cut between the cutting edges at angles of the second and third portions 11 and 12. This increases the hedge trimmer's flexibility to work effectively on cutting thick as well as thin branches.

The cutting edges of the second portion 11 will cause a particularly tough branch to be pushed out of the cutting region 12 rather than jamming and damaging the blades. These awkward branches can be progressively weakened and reduced in diameter with the cutting edges at 12 and 11 before eventually moving down the teeth to 9 where it they are sliced through.

A different embodiment of a first blade according to the present invention is shown in FIG. 4. In this third embodiment the blade teeth 30 have a profile on one side of the teeth between the root 41 and the tip 42 that is shaped to include a curved profile 43 forming a first portion 44 and a second portion 45 and a flat on the tip 42 (third portion). Both sides of the tooth are sharpened but the flattened tip stops the top sides meeting in a point. This embodiment provides a more gradual transition between the bevelled portions 10 and 11 shown in FIG. 1 which makes a smoother cutting action as material moves towards the root of the tooth. The two portions of the cutting edge 43 can be identified by the tangent of the curve within the regions of 44 and 45. The concave profile 46 on the opposite cutting edge can hold branches into the cutting path.

FIG. 5 shows a fourth embodiment of the invention. Here the cutting edge has an extended second portion 52 and a reduced first portion 51. Extending the second portion of the cutting blade makes the blade more suitable for cutting larger branches. Incorporating the first portion into the design of cutting edge close to the root of the tooth allows a finer cut to be achieved on smaller branches which can be cleanly sliced through. While the angle of the cutting edge in the first portion imparts a large force on the blade this is acceptable since only smaller branches can access this region of the blade and the wide root design maintains the tooth strength.

FIG. 6 shows a fifth embodiment of the invention featuring a flat tip 61 and curved cutting edges 62 on both sides of the teeth, the curved edges comprising the first cutting portion 63 and the second cutting portion 64.

1. A blade for a hedge trimmer having a long axis and comprising a plurality of cutting teeth, each tooth having a longitudinal axis extending laterally away from the long axis of the blade, each cutting tooth comprising a root and a tip and opposing sides extending between the root and the tip, wherein at least one of the cutting teeth comprises a special tooth which is sharpened along at least one side to form a cutting edge, in which a first portion of the cutting edge is bevelled such that a tangent line to the first portion is inclined at an angle of between 1 degrees and 12 degrees relative to the longitudinal axis of the tooth, and a second portion of the cutting edge closer to the tip of the tooth than the first portion and which is bevelled such that a tangent line to the second portion is inclined at an angle relative to the longitudinal axis of the tooth of between 8 degrees and 25 degrees, the angle of inclination of the second portion being greater than that of the first portion.

2. A blade according to claim 1 in which each bevelled portion comprises a substantially straight linear segment whereby the tangent line for that portion will overlie the whole of the portion with the line considered to be a portion of a perimeter of a circle of infinite radius.

3. A blade according to claim 1 in which each bevelled portion is curved such that the tangent line is an imaginary line that just touches the curved portion at a point along its length.

4. A blade according to claim 1 in which the first and second bevelled portions are adjacent and meet at a point.

5. A blade according to claim 1 in which an additional portion connects the first portion and second portion such that an end of the first portion and an end of the second portion are tangential to respective ends of the curved portion.

6. A blade according to claim 1 in which the first portion and second portion are inclined inwardly from the root end of the tooth to the tip end such that the width of the tooth from its longitudinal axis to the sharpened edge along each of these portions narrows with increasing distance from the root of the tooth.

7. A blade according to claim 1 in which the first portion inclines outwards from the tooth axis whilst the second portion is inclined inwards with increasing distance from the root of the tooth.

8. A blade according to claim 1 in which the first portion extends over a lower or a central region of the cutting edge, and the second portion extends across an upper region of the cutting edge.

9. A blade according to claim 1 in which each of the first portion and second portion extend along at least 10 percent.

10. A blade according to claim 8 in which the lower region of the first portion is located at most half way up the cutting edge, and the upper region is located at least 60 percent of the way from the tip of the tooth.

11. A blade according to claim 1 in which the second portion extends over at least 50 percent, 80 percent or substantially 100 percent of the upper 25 percent of the tooth cutting edge.

12. A blade according to claim 1 in which the transition between the first portion and the second portion is located between 20 percent and 90 percent of the distance from the root to the tip of the tooth as measured from the root of the tooth.

13. A blade according to claim 1 in which the first portion extends over a length of the cutting edge with one end located approximately one quarter of the way up the cutting edge, measured from the root, to about one half of the way, and the second portion extending from about half of the way to the top of the tooth cutting edge, or close to the top of the cutting edge.

14. A blade according to claim 1 in which the first portion and second portion are shaped such that for any point on the edge its tangent is the same as, or inclined at a greater angle than, any lower point on the edge.

15. A blade according to claim 1 in which the tip of the tooth comprises a third portion which is inclined relative to the long axis of the blade at an angle of between 4 degrees and 20 degrees extending from one side edge of the tooth to its length axis and which in use provides a sawing action.

16. A blade according to claim 15 in which the third portion is so shaped as to provide two acute corners on the tip of the tooth.

17. A blade according to claim 15 in which the angle of the first portion is about 6 degrees, the second portion is about 12 degrees and the angle of the third portion is around 5 degrees.

18. A blade according to claim 1 which includes at least two special teeth which are adjacent and one or more normal teeth which comprise opposing sharpened cutting edges that taper linearly towards the centre axis of the tooth from a point at or near to the root of the tooth to a point at or near the tip of the tooth.

19. A blade according to claim 18 in which the special teeth are located at the end of the blade which, in use, is furthest from the handle of the hedge trimmer with the normal teeth being located closer to the handle of the trimmer.

20. A hedge trimmer comprising at least two blades, in which a first blade and a second blade, the first blade comprising a long axis and a plurality of cutting teeth, each tooth having a longitudinal axis extending laterally away from the long axis of the blade, each cutting tooth comprising a root and a tip and opposing sides extending between the root and the tip, characterised in that at least one of the cutting teeth comprises a special tooth which is sharpened along at least one side to form a cutting edge, in which a first portion of the cutting edge is bevelled such that a tangent line to the first portion is inclined at an angle of between 1 degrees and 12 degrees relative to the longitudinal axis of the tooth, and a second portion of the cutting edge closer to the tip of the tooth than the first portion and which is bevelled such that a tangent line to the second portion is inclined at an angle relative to the longitudinal axis of the tooth of between 8 degrees and 25 degrees, the angle of inclination of the second portion being greater than that of the first portion.

21. A hedge trimmer according to claim 20 in which the second blade also comprises teeth spaced along a long axis of the blade, at least one of the teeth of the second blade being longer from root to tip than the teeth of the first blade to provide extensions which restrict contact between oversized branches and the teeth of the first blade.
